(19) United States
(12) Patent Application Publication
(10) Pub. No.: US 2007/0260450 A1
(43) Pub. Date: Nov. 8, 2007

(54) Indexing parsed natural language texts for advanced search

(76) Inventor: Yudong Sun, Cupertino, CA (US)

Correspondence Address: Hickman Palmero Truong & Becker LLP/;Yahoo! Inc., 2055 Gateway Place, Suite 550, San Jose, CA, 95110-1089, US

(21) Appl. No.: 11/418,886

(22) Filed: May 5, 2006

(51) Int. Cl. G06F 17/27

(52) U.S. Cl. 704/9

(57) ABSTRACT

Techniques are provided for enhancing a search index to indicate the grammatical contexts of words. In one aspect, a hierarchy is generated for a sentence. The hierarchy is based on the sentence's grammatical structure. Grammatical and positional values are determined for each node in the hierarchy. Each node's grammatical value indicates the grammatical function of a word corresponding to that node. Each node's positional value indicates that node's position in the hierarchy. Traversing the hierarchy downward from the root to a particular node yields an associated sequence of other nodes that occur in the particular node's branch. The grammatical value-positional value pairs associated with the nodes in the sequence are representative of the grammatical context of the particular node's corresponding word. Data that indicates the pairs associated with the nodes in the particular node's associated sequence are stored in a search index entry for the particular node's corresponding word.

### FIELD OF THE INVENTION

The present invention relates to search engines and natural language processing.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Search engines that enable computer users to obtain references to web pages that contain one or more specified words are now commonplace. Typically, a user can access a search engine by directing a web browser to a search engine “portal” web page. The portal page usually contains a text entry field and, sometimes, a button control. The user can initiate a search for web pages that contain specified query terms by typing those query terms into the text entry field. When the button control is activated, or when a script executing on the portal web page determines that a specified event has been occurred, the query terms are sent to the search engine, which typically returns, to the user's web browser, a dynamically generated web page that contains a list of references to other web pages, or documents, that contain the query terms.

To generate the list of references, the search engine typically consults a search index. The search index is sometimes called an “inverted word table.” The search index may be compared to an index at the back of a book, which indicates, for each word in a set of selected words, a list of page numbers of pages on which that word occurs in the book. Similarly, the search index may contain, for each word that occurs within any document in a search corpus (a set of documents that have been discovered by an automated “web crawler”), a list of entries that indicate the identities of the documents in which that word occurs. If a word occurs multiple times in the search corpus, then the list associated with that word may contain multiple entries.

Each such entry also may indicate the position or order of that word relative to other words in the document identified by the entry. For example, if a particular word is the seventy-third word in a particular document, then an entry associated with the particular word may indicate both (a) a unique value that distinguishes the particular document from other documents in the search corpus and (b) the value “73.” If a particular word occurs several times in the same document, then the list associated with the word in the search index may contain separate entries for each occurrence; these entries would identify the same document but different locations of the particular word within that document.

Thus, to generate a list of references that include a particular query term, the search engine may locate the particular query term in the search index and discover the list of entries associated with the particular query term. If there are multiple query terms, then the search engine may discover a separate list of entries for each query term. As is discussed above, each such entry identifies the document in which the associated query term occurs. By determining the intersection of the sets of documents associated with the various query terms, a set of documents in which all of the query terms occur may be formed.

If a condition of the query is that the query terms must occur adjacent to each other in a specified order (i.e., as a phrase) in a document before a reference to that document can be included in a list of search results, then the word positions indicated in the entries associated with the query terms may be compared to determine whether the words are adjacent to each other in the specified order. References to documents in which all of the query terms occur, but not adjacent to each other or not in the specified order, may be excluded from the list of search results that the search engine returns.

The foregoing approach works well enough when a user of the search engine wants only to determine a set of documents that contain a specified word or phrase. However, the foregoing approach often does not work well when the user wants to determine a set of documents that contain an answer to a question that is expressed in a natural language. The grammatical structure of such a question conforms to the grammatical rules of the natural language in which the question is expressed. For example, a question might be expressed as the sentence, “When did Chris know that Terry would catch the ball?”

Using the foregoing approach, a search engine might treat each word in such a question as a separate query term. However, documents that contain text that is relevant to the question might (and probably do) omit some of the words in the question, and/or contain those words in an order that is different than the order in which those words occur in the question. Thus, the foregoing approach will often return a list of references to documents that are not the most relevant. The limitations of the foregoing approach arise from the fact that the search index does not contain any information about the grammatical context in which words occur.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a flow diagram that illustrates a technique for generating data that represents the grammatical context of words and/or phrases in a sentence, according to an embodiment of the invention;

FIG. 2 shows a diagram of an example hierarchical structure that corresponds to an example sentence, according to an embodiment of the invention;

FIG. 3 shows a diagram in which positional values have been associated with each of the nodes in the hierarchical structure of FIG. 2, according to an embodiment of the invention;

FIG. 4 shows a diagram in which grammatical values have been associated with each of the word-representing or phrase-representing nodes in the hierarchical structure of FIG. 2, according to an embodiment of the invention; and

FIG. 5 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to one embodiment of the invention, a search index, such as an inverted word table, is enhanced to include information that indicates the grammatical contexts of words that occur in a search corpus. For example, in one embodiment of the invention, each document (e.g., web page) in a search corpus is divided into sentences. Based on the grammatical rules of a natural language, a separate hierarchical structure (e.g., a tree structure) is generated for each sentence. Each hierarchical structure is based on the grammatical structure of the sentence that the hierarchical structure represents.

The nodes in each hierarchical structure correspond to words or phrases in the sentence that the hierarchical structure represents. For each hierarchical structure, a separate grammatical value and positional value are determined for each node in that hierarchical structure. Thus, a grammatical value/positional value pair is associated with each node. Each node's grammatical value indicates the grammatical function (e.g., part of speech) of the word or phrase represented by that node. Each node's positional value indicates the position of that node relative to other nodes in the hierarchical structure.

For each particular node in a plurality of nodes in the hierarchical structure, traversing the hierarchical structure downward from the root of the hierarchical structure to the particular node yields an associated sequence of one or more other nodes that occur in a same branch of the hierarchical structure in which the particular node occurs, but closer to the root of the hierarchical structure. The grammatical value/positional value pairs associated with the nodes in the sequence are representative of the grammatical context of the word or phrase represented by the particular node.

In one embodiment of the invention, for each particular node, data that indicates the grammatical value/positional value pairs associated with the nodes in the particular node's associated sequence are stored, in the search index, in an entry that is associated with the word or phrase that the particular node represents. For example, an entry that is associated with a particular word may indicate, in addition to (a) a document identification value that uniquely identifies, in the search corpus, a document in which the particular word occurs and (b) a sentence identification value that uniquely identifies a sentence, within that document, in which the particular word occurs, (c) the data that indicate the grammatical context of the word within that sentence based on the associated sequence of grammatical value/positional value pairs discussed above.

The enhanced search index may be used to select, from a search corpus, one or more documents that contain text that is relevant to a question that is expressed according to the grammatical rules of a natural language. Thus, in response to receiving a set of query terms that express such a question, a search engine may determine a set of documents that contain text that is relevant to that question and return, as search results, a list of references (e.g., links) to those documents (or even the potential answers indicated within those documents).

### Example Technique

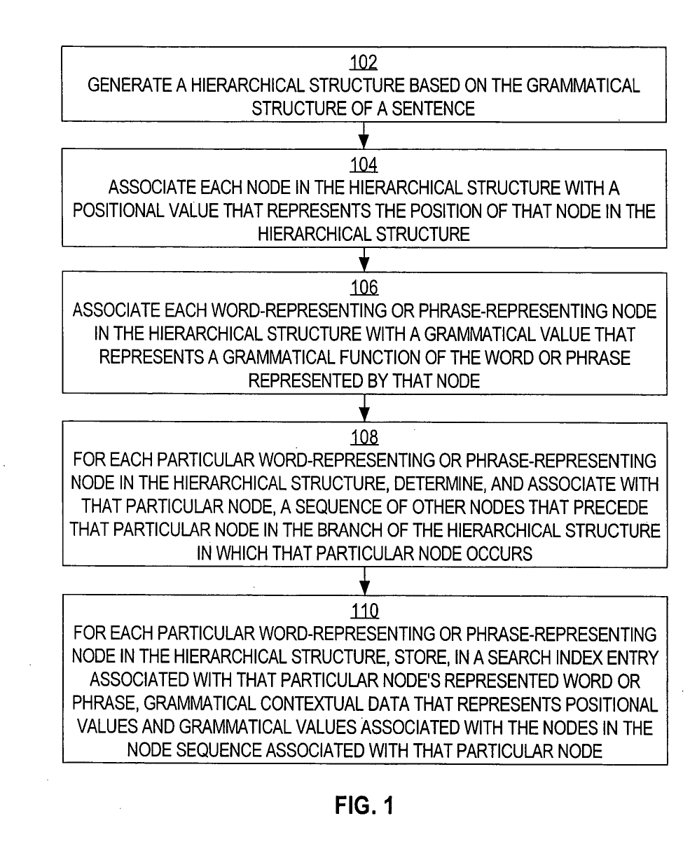

FIG. 1 shows a flow diagram that illustrates a technique for generating data that represents the grammatical context of words and/or phrases in a sentence, according to an embodiment of the invention. The technique may be performed automatically by a computer, for example. The technique described below assumes that a search corpus, comprising one or more documents (e.g., web pages), has been constructed. The technique assumes that each document in the search corpus has been associated with a document identification value that distinguishes that document from all of the other documents in the search corpus. Each document identification value is unique among document identification values.

The technique additionally assumes that the discrete sentences occurring within one or more documents in the search corpus have been identified (e.g., through automatic means), and that each such sentence has been associated with a sentence identification value that indicates the position, or order, of that sentence relative to the other sentences in the document in which that sentence occurs. For example, the first sentence that occurs in a document may be associated with a sentence identification value of “1,” the second sentence that occurs in that document may be associated with a sentence identification value of “2,” and so forth. The technique described below may be performed for each such sentence.

In block 102, a hierarchical structure is generated based on the grammatical structure of a sentence. The hierarchical structure may take the form of a tree of nodes, for example, in which at least some nodes represent words or phrases in the sentence. Nodes in the hierarchical structure may represent the sentences' words or phrases that have distinct grammatical functions. In one embodiment of the invention, fewer than all of the nodes in the hierarchical structure represent words or phrases in the sentence.

Although there are many different possible ways in which such a hierarchical structure could be generated, one way might involve determining a grammatical function for a phrase in the sentence, creating a node for that phrase in the hierarchical structure, determining whether any sub-phrases in that phrase have grammatical functions that are distinct from the grammatical function of the phrase, and, if so, removing those sub-phrases from the phrase and creating nodes for those sub-phrases such that the sub-phrases' nodes are children, in the hierarchical structure, of the phrase's node. This process then may be performed recursively on each of the sub-phrases, treating each of those sub-phrases in the same manner as the phrase described above.

For example, through automated parsing, a sentence may be expressed hierarchically in “Penn Treebank Notation.” Penn Treebank Notation is described in “Building a large annotated corpus of English: the Penn Treebank,” by Marcus, M., Santorini, B., and Marcinkiewicz, M. A., in Computational Linguistics, vol. 19 (1993), which is incorporated by reference herein. According to Penn Treebank Notation, different grammatical parts of a sentence are annotated with grammatical symbols that indicate the grammatical functions of those grammatical parts. For example, in Penn Treebank Notation, the sentence “Chris knew yesterday that Terry would catch the ball” may be expressed, approximately, as follows:

(S (NP-SBJ Chris)

(VP knew

(NP-TMP yesterday)
(SBAR that

(S (NP-SBJ Terry)

(VP would

(VP catch

(NP the ball)))))))

In the foregoing notation, the symbol “S” means “sentence,” the symbol “NP” means “noun phrase,” the symbol “NP-SBJ” means “noun phrase—subject,” the symbol “NP-TMP” means “noun phrase—temporal,” the symbol “VP” means “verb phrase,” and the symbol “SBAR” means “subordinate clause.” This is only one example; other schemes could grammatically classify words or phrases in the sentence with greater or lesser specificity, and/or in a different manner.

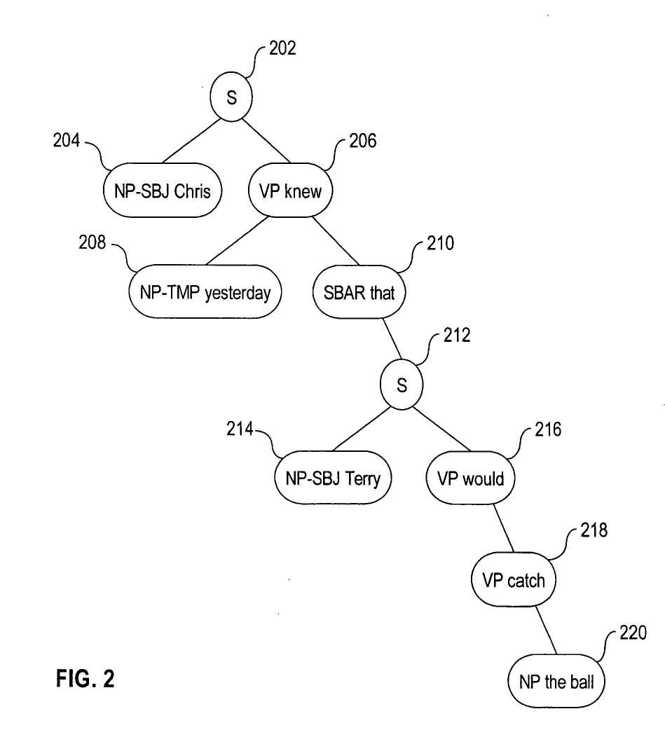

FIG. 2 shows a diagram of an example hierarchical structure that corresponds to the sentence, “Chris knew yesterday that Terry would catch the ball,” according to an embodiment of the invention. Node 202 represents the beginning of a sentence or sub-sentence, and does not represent any word. Node 202 has two children: nodes 204 and 206. Node 204 represents the word “Chris,” which, in the sentence, has the grammatical function of “noun phrase—subject.” Node 206 represents the word “knew,” which, in the sentence, has the grammatical function of “verb phrase.” Node 206 has two children: nodes 208 and 210. Node 208 represents the word “yesterday,” which, in the sentence, has the grammatical function of “noun phrase—temporal.” Node 210 represents the word “that,” which, in the sentence, has the grammatical function of “subordinate clause.” Node 210 has one child: node 212.

Like node 202, node 212 represents the beginning of a sentence or sub-sentence, and does not represent any word. Node 212 has two children: nodes 214 and 216. Node 214 represents the word “Terry,” which, in the sentence, has the grammatical function of “noun phrase—subject.” Node 216 represents the word “would,” which, in the sentence, has the grammatical function of “verb phrase.” Node 216 has one child: node 218. Node 218 represents the word “catch,” which, in the sentence, has the grammatical function of “verb phrase.” Node 218 has one child: node 220. Node 220 represents the phrase “the ball,” which, in the sentence, has the grammatical function of “noun phrase.” Node 220 has no children.

Referring again to FIG. 1, in block 104, for each node in the hierarchical structure, a distinct positional value is associated with that node. The positional value associated with a node differs from the positional values associated with all other nodes in the hierarchical structure. For example, positional values may be associated with the nodes of the hierarchical structure by traversing the hierarchical structure in beginning at the root node (e.g., node 202) and associating positional values, in an incremental manner, to each of the nodes traversed. The hierarchical structure may be traversed in a breadth-first or depth-first manner. For example, the first word-representing or phrase-representing node traversed may be associated with a positional value of “1,” the second word-representing or phrase-representing node traversed may be associated with a positional value of “2,” and so forth.

Exceptionally, in one embodiment of the invention, the root node of the hierarchical structure is associated with the sentence identification value of the sentence that the hierarchical structure represents, instead of the positional value of “1.” For example, if the sentence represented by the hierarchical structure is the 256^{th} sentence in the document in which that sentence occurs, then the root node of the hierarchical structure may be associated with a positional value of “256.” In such an embodiment, the first node traversed after the root node may be associated with the positional value of “1.”

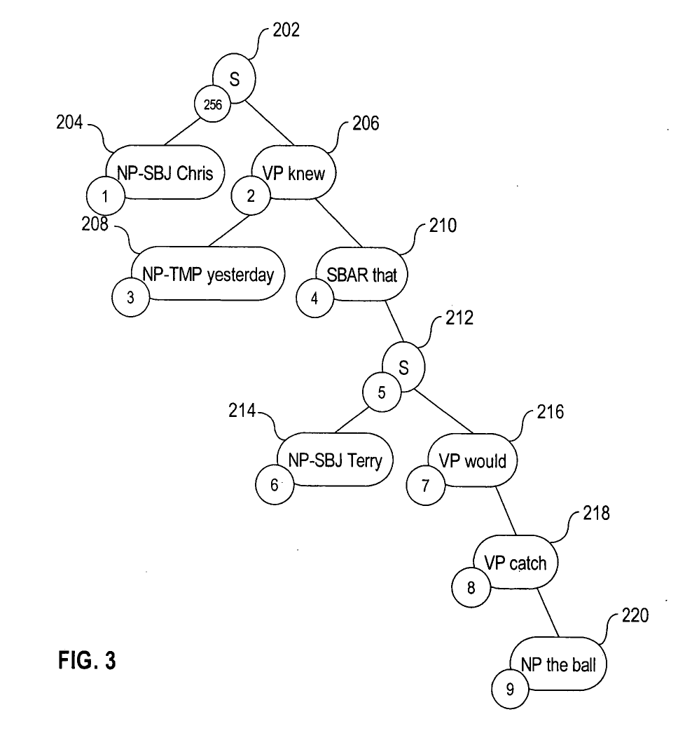

FIG. 3 shows a diagram in which positional values have been associated with each of the nodes in the hierarchical structure of FIG. 2, according to an embodiment of the invention. Nodes 204-220 are associated with positional values based on a breadth-first traversal of the hierarchical structure. The positional values associated with nodes 202-220 are shown in circles connected to the nodes with which the positional values are associated.

In this example, node 202 (the root node) is associated with a positional value of “256,” since, in this example, the sentence represented by the hierarchical structure is associated with a sentence identification value of “256.” In this example, node 204 is associated with a positional value of “1,” node 206 is associated with a positional value of “2,” node 208 is associated with a positional value of “3,” node 210 is associated with a positional value of “4,” node 212 is associated with a positional value of “5,” node 214 is associated with a positional value of “6,” node 216 is associated with a positional value of “7,” node 218 is associated with a positional value of “8,” and node 220 is associated with a positional value of “9.”

Referring again to FIG. 1, in block 106, for each word-representing or phrase-representing node in the hierarchical structure, a grammatical value is associated with that node. The grammatical value associated with each node represents the grammatical function of the word or phrase that the node represents. Regardless of the scheme used to classify, grammatically, the words and phrases in the sentence, each grammatical classification used in the scheme to classify words or phrases may correspond to a different grammatical value. In the foregoing example, the classification “noun phrase” may correspond to the grammatical value “1,” the classification “noun phrase—subject” may correspond to the grammatical value “2,” the classification “noun phrase—temporal” may correspond to the grammatical value “3,” the classification “verb phrase” may correspond to the grammatical value “4,” and the classification “subordinate clause” may correspond to the grammatical value “5.”

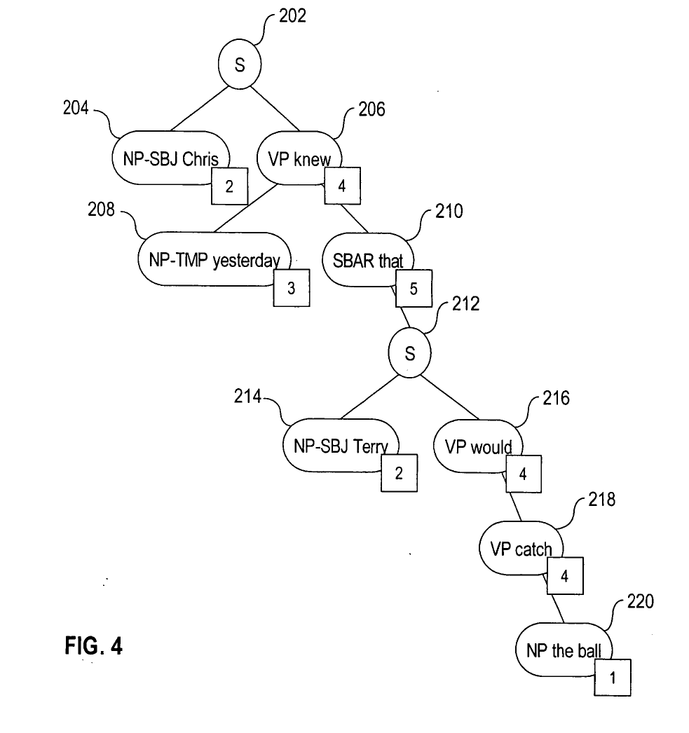

FIG. 4 shows a diagram in which grammatical values have been associated with each of the word-representing or phrase-representing nodes in the hierarchical structure of FIG. 2, according to an embodiment of the invention. In this example, nodes 204-210 and nodes 214-220 are associated with grammatical values that are based on the Penn Treebank Notation symbols with which the words and phrases represented by those nodes are annotated. Nodes which represent words or phrases that have the same grammatical function in the sentence are associated with the same grammatical values. The grammatical values associated with nodes 204-210 and nodes 214-220 are shown in squares connected to the nodes with which the grammatical values are associated. No grammatical values are associated with nodes 202 and 212 in this example, because nodes 202 and 212 do not represent a word or phrase.

In this example, because the phrase “the ball” has the grammatical function “noun phrase,” node 220 is associated with a grammatical value of “1.” Because the words “Chris” and “Terry” both have the grammatical function “noun phrase—subject,” nodes 204 and 214 are both associated with a grammatical value of “2.” Because the word “yesterday” has the grammatical function “noun phrase—temporal,” node 208 is associated with a grammatical value of “3.” Because the words “knew,” “would,” and “catch” all have the grammatical function “verb phrase,” nodes 206, 216, and 218 are all associated with a grammatical value of “4.” Because the word “that” has the grammatical function “subordinate clause,” node 210 is associated with a grammatical value of “5.”

According to one embodiment of the invention, words and phrases may have more than one grammatical function within the sentence in which they occur. In such an embodiment of the invention, the nodes that represent those words or phrases may be associated with multiple grammatical values—one grammatical value for each distinct grammatical function that the node's represented word or phrase has. Thus, each node in the hierarchical structure is associated with a positional value and zero or more grammatical values.

Referring again to FIG. 1, in block 108, for each particular word-representing or phrase-representing node in the hierarchical structure, a sequence of other nodes that precede (i.e., occur “higher up” in the hierarchical structure than) that particular node in the particular node's branch of the hierarchical structure is determined and associated with that particular node. For example, the sequence of other nodes to be associated with a particular node may be determined by traversing the hierarchical structure from the root node down to the particular node in a depth-first manner, adding the traversed nodes to the sequence along the way.

For example, the node sequence associated with node 220 would be: node 202, node 206, node 210, node 216, node 218, and node 220. For another example, the node sequence associated with node 208 would be: node 202, node 206, and node 208.

In block 110, for each particular word-representing or phrase-representing node in the hierarchical structure, a search index entry that indicates grammatical contextual data regarding the word or phrase that the node represents is stored in association with that word or phrase in the search index (e.g., inverted word table). Multiple search index entries may be associated with each word or phrase in the search index.

In one embodiment of the invention, for each particular word-representing or phrase-representing node in the hierarchical structure, the grammatical contextual data stored in an entry associated with that particular node's word or phrase represents, for each other node in the node sequence that is associated with that particular node, (a) the positional value associated with that other node, and (b) the grammatical values associated with that other node (if any). In one embodiment of the invention, the positional and grammatical values are represented in the order in which the nodes associated with these values occur in the node sequence.

In one embodiment of the invention, the grammatical contextual data additionally indicates the document identification value of the document in which the sentence represented by the hierarchical structure occurs. In one embodiment of the invention, if the positional value associated with the root node of the hierarchical structure is not the sentence identification value of the sentence represented by the hierarchical structure, then the grammatical contextual data additionally indicates the sentence identification value.

Therefore, based on the foregoing example, a search index entry stored in association with the word “catch” (represented by node 218) might contain grammatical contextual data that represents (a) a document identification value and (b) the following example sequence of positional value/grammatical value pairs: (256, 0), (2, 4), (4, 5), (5, 0), (7, 4), (8, 4). The example sequence indicates, for each node in the node sequence associated with node 218 (i.e., each node in the same branch of the hierarchical structure are node 218), both (a) the positional value associated with that node and (b) the grammatical value associated with that node (or “0” if no grammatical value is associated with that node).

The grammatical contextual data in the search index entry provides a search engine with a detailed notion of the grammatical context of the word “catch” within a specific document and sentence. The search engine may use this grammatical context, for example, to determine, more accurately and efficiently, which documents in the search corpus might contain text that is relevant to the natural language-expressed question, “When did Chris know that Terry would catch the ball?” Using grammatical contextual data, the search engine may find documents that might contain relevant text even if those documents do not contain all of the words in the question, and even if some of the words in the question are expressed in a different order in the documents. Indeed, using grammatical contextual data, the search engine may determine which portion of a document indicates a potential answer to the question, and present that potential answer as a search result to a user.

As is discussed above, the grammatical contextual data stored in the search index entry represents specific information, such as the positional values and grammatical values of nodes in a node sequence (i.e., in a branch of a hierarchical structure). However, the form in which the grammatical contextual data represents this information may vary from implementation to implementation. Some of the various forms in which the grammatical contextual data may represent this information are discussed below.

### Grammatical Contextual Data Storage Forms

Grammatical contextual data stored in a search index entry that is associated with a word or phrase represents one or more positional values and one or more grammatical values. In one embodiment of the invention, all of the positional values and grammatical values associated with nodes in a particular node's associated node sequence are stored in a search index entry associated with the particular node's word or phrase. For example, in such an embodiment, the sequence (256, 0), (2, 4), (4, 5), (5, 0), (7, 4), (8, 4) might be stored in association with the word “catch.” In such an embodiment, grammatical values are represented and stored as integer values.

However, in an alternative embodiment of the invention, grammatical values are represented and stored as bit fields instead of integer values. In such an embodiment, each different grammatical function that a word or phrase might have corresponds to a different position in the bit field. If a word or phrase has a particular grammatical function, then the bit at the position corresponding to that particular grammatical function is set in a bit field that is associated with the node that represents that word or phrase; otherwise, the bit at that position is not set in that bit field. Thus, if a word or phrase has multiple grammatical functions, then the bit field associated with the node that represents that word or phrase may contain multiple bits that are set.

For example, the classification “noun phrase” may correspond to the first bit in the bit field, the classification “noun phrase—subject” may correspond to the second bit in the bit field, the classification “noun phrase—temporal” may correspond to the third bit in the bit field, the classification “verb phrase” may correspond to the fourth bit in the bit field, and the classification “subordinate clause” may correspond to the fifth bit in the bit field.

In one embodiment of the invention, less than all of the positional values associated with nodes in a particular node's associated node sequence are stored in the search index entry associated with the particular node's word or phrase. For example, in one embodiment of the invention, the positional value associated with the particular node itself is not stored in the search index entry; that positional value may be inferred from the other information in the search index entry.

### Branch Templates

As is discussed above, a hierarchical structure may be a tree of nodes. Such a tree might comprise multiple different branches that extend from the root node to other nodes in the tree; a tree may comprise as many different branches as there are nodes in the tree, minus one. Each branch represents a path from the root node to a node other than the root node. Defined in this manner, a branch may, but does not need to, include a leaf node of the tree.

Also as is discussed above, a separate hierarchical structure may be generated for each sentence that occurs in a search corpus. According to the foregoing technique, the nodes in these hierarchical structures are associated with positional values and, in some cases, grammatical values.

Even though the sentences represented by two or more separate hierarchical structures may be different, the hierarchical structures that represent those sentences, and the positional and grammatical values associated with the nodes in those hierarchical structures, sometimes may be very similar or exactly the same. This is especially so in embodiments of the invention in which the positional value of the root node is not set to be equal to a sentence identification value. The similarity in hierarchical structures may be expected due to the similarities in the grammatical structures of many different sentences-especially very simple sentences.

Even in cases where two or more hierarchical structures are not exactly the same, at least some of the branches occurring within different ones of those hierarchical structures, and the positional and grammatical values associated with the nodes in those branches, might still be exactly the same. Branches that commonly occur among hierarchical structures may be represented in a more compact form, thus conserving storage space and reducing the size of the search index.

Therefore, according to one embodiment of the invention, selected branches, represented as sequences of positional values and grammatical values associated with the nodes that occur in those branches, are stored as “branch templates.” In one embodiment of the invention, before grammatical contextual data is stored in a search index entry in association with a word or phrase (as is described above with reference to block 110 of FIG. 1), a determination is made as to whether the sequence of positional and grammatical values represented by that grammatical contextual data matches any of the previously stored branch templates. If there is a match, then, instead of the sequence of positional and grammatical values, a reference to the matching branch temple is stored in the search index entry. The reference may be a branch template identification value, for example. Usually, the reference occupies less storage space than the sequence does. Thus, commonly occurring sequences—branches—may be stored once and referenced multiple times.

According to one embodiment of the invention, if there is no match between a sequence and previously stored branch template, then a new branch template that matches the sequence is stored, and a reference to that new branch template is stored in the search index entry instead of the sequence. In one embodiment of the invention, new branch templates are automatically stored only if they satisfy specified criteria (e.g., being simple enough that they are likely to be referenced by at least a specified number of search index entries).

### Using Grammatical Contextual Data in a Search

According to one embodiment of the invention, when a search engine receives query terms, the search engine can (a) return search results that contain sentences that are relevant to the query terms and/or (b) return a potential answer to a question that the query terms express. The query terms might, but do not need to, express a question.

In one embodiment of the invention, when query terms express a question, the search engine parses the question and generates a corresponding sentence in non-question form. For example, if the search engine receives, as query terms, the question “When did Chris know that Terry would catch the ball?” then the search engine might responsively generate the corresponding sentence, “Chris knew [when] that Terry would catch the ball.” Subsequent search will be conducted mostly based on this non-question form of the original query. Alternatively, if the query terms do not express a question, then the search engine does not need to generate a non-question form of the query terms.

According to one embodiment of the invention, the search engine will conduct the search based on known words in the sentences. Thus, in the above example, the word “when” would not be used to used to conduct the search. Additionally, one or more other query terms might not be used to conduct the search if those terms are deemed to be unimportant. For example, the word “that” might be deemed an unimportant term that should not be used to conduct the search.

According to one embodiment of the invention, the search engine attempts to locate an “exact” sentence match, i.e. it locates the same words used in the same grammatical context as in the query sentence. Note that the matched document sentence may contain other extra elements, as long as it contains the query sentence; in other words, it's an “exact” match as long as the document sentence parse tree contains a subtree that's the same as the query sentence parse tree. According to an alternative embodiment of the invention, the search engine attempts to locate a non-exact match, which may be based to some extent on the process that is used to attempt to locate an exact match. In other words, it is a non-exact match if the document sentence parse tree contains a subtree that is equivalent to (but not exactly the same as) the query sentence parse tree.

In the case where the search engine attempts to locate an exact match, the search engine and/or other entities may perform the following actions. First, known words in the query sentence are used to locate corresponding word entries in the search index. Next, matching entries are selected based on whether the words are in the same document and whether the words are in the same sentence.

For those matching words that are in the same sentence, a further grammatical context/function match may be performed. The match is deemed to be a success if the matching words are in the same grammatical context as the words in the natural language sentence that is represented by the query terms. As a result, a list of word entry combinations that match the sentence represented by the query terms is obtained; each word entry combination in the list logically corresponds to one search result.

The list of search results is generated to contain reference to documents that contain the matching word entry combinations. In the list of search results presented to the user, the relevant sentences and/or words may be highlighted. For example, in the matched document sentence, “Chris knew yesterday that Terry would catch the ball,” all of the words except “yesterday” (i.e. all words from the query terms used to do the search) might be highlighted in the search results.

However, in the above example, where the query term sentence is a question, without further processing, the search engine might not be able to determine where the temporal part of the matched document sentence (“yesterday”) is, or even whether the matched document sentence has a temporal part. According to one embodiment of the invention, no further processing is performed, and the user is left to attempt to determine the temporal part on his own in the search result. According to another embodiment of the invention, the “answer” part of each search result is highlighted in the list of search results; in one embodiment of the invention, only those search results that contain an “answer” part are presented to the user. For example, in the search result sentence, “Chris knew yesterday that Terry would catch the ball,” the word “yesterday” may be highlighted as the “answer” part of the question that is represented by the query terms as a whole; alternatively, only the answer part of each search result sentence may be presented in the list of search results without the non-answer parts of those search result sentences. In these embodiments of the invention that pinpoint answers to the query question, the sentences contained in the search results may be re-parsed at search time in order to locate the rest of the sentence structure occupied by words other than the words used to conduct the search; this is so, if at indexing time words are only captured in the inverted word table supporting only word to sentence lookups but not the reverse.

Additionally or alternatively, sentences that do not exactly match the query terms may be returned in the list of search results. The syntax of the sentences returned in the list of search results may vary from the syntax of the sentence represented by the query terms. For example, the matching process might consider the parse trees of the following two sentences to be equivalent for matching purposes: “Smith asks him to come here,” and “Smith asks that he come here.” Other similar or equivalent syntactical variants may also be used this way. In addition, unimportant words in the query terms, like “that,” for example, may be disregarded when matching is performed.

Furthermore, the sentence represented by the query terms might be broken into multiple parts. For example, the query term sentence, “Chris knew that Terry would catch the ball” might be broken into two parts: “Chris knew” and “Terry would catch the ball.” For each part, the search engine may perform a separate search. Any matching top-level sentences or subordinate clauses in the search index may be included in the list of search results. In one embodiment of the invention, if the matching words for each of the different parts of the query sentence are near each other (in terms of word positions) in the document in which all of those matching words occur, then those matching words may be combined into a single search result in the list of search results. In the list of search results, the matching, relevant sentences may be highlighted.

Also, if advanced techniques are available in terms of figuring out relations between sentences, for example, what word in the context a pronoun refers to, they may be used in the above process, rather than the word position closeness measure.

### Hardware Overview

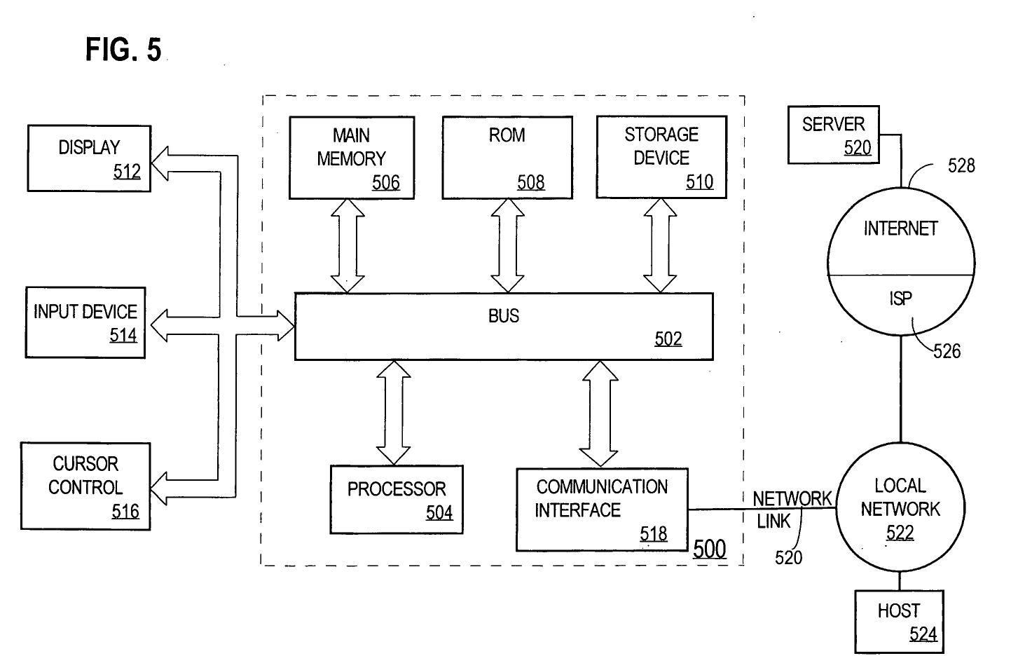

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform particular steps;
wherein the particular steps comprise performing, for each particular word of a plurality of words in a sentence that is represented by a hierarchical structure, steps comprising:
associating the particular word with a positional value that is based on a position of the particular word within the hierarchical structure;
determining a sequence of other words that occur both (i) in a same branch of the hierarchical structure in which the particular word occurs, and (ii) closer to a root of the hierarchical structure than the particular word; and
storing, in an index, an entry that associates the particular word with data that indicates, for each other word in the sequence of other words, a positional value associated with the other word.

2. The method of claim 1, wherein the particular steps further comprise performing, for each particular word of the plurality of words, steps comprising:
associating the particular word with a grammatical value that indicates a grammatical function of the particular word within the sentence; and
storing, in an index entry associated with the particular word, data that indicates, for each other word in the sequence of other words, a grammatical value associated with the other word.

3. The method of claim 1, wherein the particular steps further comprise performing, for each particular word of the plurality of words, steps comprising:
storing, in an index entry associated with the particular word, data that indicates a grammatical function of the particular word within the sentence.

4. The method of claim 1, wherein the step of associating each word in the hierarchical structure with a positional value comprises traversing the hierarchical structure and associating a different positional value with each traversed node in the hierarchical structure.

5. The method of claim 1, wherein the particular steps further comprise performing, for each particular word of the plurality of words, steps comprising:
associating the particular word with a grammatical value that indicates a part of speech selected from among a set of two or more specified parts of speech; and
storing, in an index entry associated with the particular word, data that indicates, for each other word in the sequence of other words, a grammatical value associated with the other word.

6. The method of claim 1, wherein the step of determining a sequence of other words comprises traversing the branch from the root to the particular word and adding, to the sequence, for each traversed node in the branch, a positional value that is associated with that traversed node.

7. The method of claim 1, wherein the particular steps further comprise performing, for each particular word of the plurality of words, steps comprising:
storing, in an index entry associated with the particular word, a document identification value that indicates in which document, of a plurality of documents, the sentence occurs.

8. The method of claim 1, wherein the particular steps further comprise performing, for each particular word of the plurality of words, steps comprising:
storing, in an index entry associated with the particular word, a sentence identification value that indicates in which sentence, of a plurality of sentences, the particular word occurs.

9. The method of claim 1, wherein the particular steps further comprise:
receiving user input that specifies a question expressed in a natural language;
selecting, based at least in part on (i) the question and (ii) grammatical values associated with words in the index, one or more documents from a plurality of documents;
generating a list of references to the one or more documents; and
displaying at least a portion of the list of references.

10. The method of claim 1, wherein the particular steps further comprise performing, for each particular word of the plurality of words, steps comprising:
associating the particular word with a number that corresponds to a Penn Treebank Notation (or other syntax notation system) symbol associated with the particular word; and
storing, in an index entry associated with the particular word, data that indicates, for each other word in the sequence of other words, a number that corresponds to a Penn Treebank Notation symbol associated with the other word.

11. The method of claim 1, wherein the particular steps further comprise performing, for each particular word of the plurality of words, steps comprising:
associating the particular word with one or more grammatical values that each indicate a different grammatical function of the particular word within the sentence; and
storing, in an index entry associated with the particular word, data that indicates, for each other word in the sequence of other words, one or more grammatical values associated with the other word.

12. The method of claim 1, wherein the particular steps further comprise performing, for each particular word of the plurality of words, steps comprising:
selecting, from among a plurality of grammatical functions, one or more grammatical functions that are performed by the particular word within the sentence;
associating the particular word with a grammatical function-representing field of bits in which a bit is set for each grammatical function of the one or more grammatical functions; and
storing, in an index entry associated with the particular word, for each other word in the sequence of other words, a grammatical function-representing field of bits associated with the other word.

13. The method of claim 1, wherein, for each individual word in a plurality of words:
the index comprises a set of one or more index entries that are associated with the individual word; and
each index entry in the set of one or more index entries that are associated with the individual word comprises:
a document identification value that identifies a document in which the individual word occurs;
a sentence identification value that identifies an order of occurrence of a sentence in which the individual word occurs relative to other sentences in a document that is identified by the document identification value; and
data that represents a sequence of two or more grammatical values that indicate grammatical functions of two or more words in a sentence that is identified by the sentence identification value.

14. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform particular steps;
wherein the particular steps comprise performing, for each particular word of a plurality of words in a sentence that is represented by a hierarchical structure, steps comprising:
associating the particular word with a positional value that is based on a position of the particular word within the hierarchical structure;
associating the particular word with a grammatical value that indicates a grammatical function of the particular word within the sentence;
determining a sequence of other words that occur both (i) in a same branch of the hierarchical structure in which the particular word occurs, and (ii) closer to a root of the hierarchical structure than the particular word; and
storing, in an index, an entry that associates the particular word with data that represents, for each other word in the sequence of other words, both a positional value associated with the other word and a grammatical value associated with the other word.

15. The method of claim 14, wherein the data comprise, for each other word in the sequence of other words, a bit field in which a different bit is set for each grammatical value that is associated with the other word.

16. The method of claim 14, wherein the data comprise a reference to a branch template to which two or more entries in the index refer.

17. The method of claim 16, wherein the branch template represents (i) a particular sequence of positional values and (ii) grammatical values that correspond to the positional values in the particular sequence.

18. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform particular steps;
wherein the particular steps comprise performing, for each particular word of a plurality of words in a sentence that is represented by a hierarchical structure, steps comprising:
associating the particular word with a positional value that is based on a position of the particular word within the hierarchical structure;
associating the particular word with a grammatical value that indicates a grammatical function of the particular word within the sentence;
determining a word sequence of words that occur both (i) in a same branch of the hierarchical structure in which the particular word occurs, and (ii) closer to a root of the hierarchical structure than the particular word;
generating grammatical contextual data that indicates an associated positional value and an associated grammatical value for each word in the word sequence;
identifying, in a plurality of branch templates, a particular branch template that matches the grammatical contextual data; and
storing, in an index entry that is associated with the particular word, a reference to the particular branch template.
